(19) United States
(12) Patent Application Publication
(10) Pub. No.: US 2011/0256770 A1
(43) Pub. Date: Oct. 20, 2011

(54) Receptacle for Electronic Devices

(76) Inventors: Oliver Opitz, Sohland (DE); Jochen Baier, Ingelfingen-Diebach (DE)

(21) Appl. No.: 13/088,545

(22) Filed: Apr. 18, 2011

(30) Foreign Application Priority Data
Apr. 20, 2010 (DE) 10 2010 027 990.0

(51) Int. Cl. H01R 13/66; H01R 24/00

(52) U.S. Cl. 439/620.15; 439/660

(57) ABSTRACT

A socket to be connected to the printed circuit board of an electronic device contains at least one receptacle for the plug-in section of a connector. Contact elements for contacting the contact elements of the connector are arranged in this receptacle. These contact elements terminate in a printed circuit board element, which is arranged in the socket. Contact elements then emanate from this printed circuit board element, which contact elements project from the socket and are provided and formed for connection with the printed circuit board of the electronic device. The electrical connection between the socket contact elements, associated with the connector, and the device contact elements, associated with the device, is brought about over the circuit-board conductors on the printed circuit board element. This printed circuit board element contains at least one electronic component, over which the connection between a socket contact element and a device contact element is routed.

This application claims the priority of the German patent application 102010027990.0. The whole disclosure of this prior application is herewith incorporated by reference into this application.

The invention relates to a socket for electronic devices, more particularly to a USB socket.

Electronic devices, for example computers, have sockets for lines, by means of which data signals are exchanged and external devices are supplied with voltage. Sockets can also serve for directly connecting e.g. storage media. Interference can also reach the device via the lines, or the interference may reach the outside from the device. Hence, it is necessary, and known, to install modules and elements into the devices, which modules and elements again filter out this interference. Such modules or elements are usually arranged on the printed circuit boards of the electronic devices because they are part of the devices.

The sockets are individual components that are produced separately and connected to the printed circuit boards. Sockets normally have shielding in the form of a metallic housing. Their main object is to accommodate the standardized connectors and to establish both a mechanical and an electrical connection.

There are at least four lines in USB connectors, specifically earth, voltage supply and two data lines. The known USB sockets accordingly have at least four contact elements, which are each formed in a continuous fashion.

A cable plug-in connector for printed circuit boards has already been disclosed (DE 10 2004 061 681 A1), which has two continuous contact elements. In the cable plug-in connector, there is space for a surge protection arrester, which is designed as a separate element and attached on a small printed circuit board. This printed circuit board is pushed into the plug-in connector, and the electrical connection between the surge suppressor and the two continuous contact elements is established with the aid of contact elements.

The invention is based on the object of improving the protection of electronic devices from interference, which originates from the outside or reaches the outside from the device, without increasing the complexity in the design and development of the electronic devices themselves.

In order to achieve this object, the invention proposes a socket with the features specified in claim 1. Developments of the invention are the subject matter of the dependent claims.

Thus, the socket proposed by the invention has the same design as the previous sockets in terms of its mechanical capabilities, and so it can be used in the same fashion as the latter. However, it no longer has continuous contact elements. Rather, the contact elements, provided for contacting the connector, terminate at a printed circuit board element within the socket, and the contact elements, provided for contacting the printed circuit board in the electronic device, then emanate from this printed circuit board element within the socket. The printed circuit board element in the socket then establishes the electrical connection between the associated contact elements.

There are very different methods for connecting such sockets with the printed circuit board in the electronic device. It may be an attachment using SMT, or an attachment using THT. The profile of the contact elements within the device, i.e. outside the housing of the socket, may also vary. All these options can likewise be effected more easily as a result of separating the contact elements.

A development of the invention may provide for the printed circuit board element arranged in the socket to have at least one electronic element, which is operatively connected to at least one line routed through the socket. More particularly, provision can be made for such an electrical or electronic component to be inserted in the connection between at least one socket contact element and at least one device contact element.

In particular, the invention proposes to carry out this measure in a USB socket.

In the case of USB sockets, at least four lines have to be routed through the socket, and so, overall, there are at least eight contact elements in the case of the subdivision of the contact elements proposed by the invention. According to the invention, provision can be made for a holding element, made of insulating material, preferably plastic, to be arranged in the socket for safely holding and storing these contact elements.

For shielding purposes, and for improving the mechanical stability, a development may provide for the socket to have a metallic housing, which surrounds and protects the holding element with the contact elements arranged therein and the printed circuit board element.

Usual connection methods, e.g. soldering, may be used for connecting the contact elements with the printed circuit board element arranged in the socket. To this end, provision can be made for the printed circuit board element to have through-plated openings, which are connected to circuit-board conductors on the printed circuit board element. Then the ends of the contact elements associated with the printed circuit board element can be plugged into these openings and can be soldered there.

It goes without saying that the corresponding elements may likewise be connected by pressing.

Irrespective of how the contact elements are connected to the printed circuit board element in the socket, the ends of the contact elements, which project out of the socket and are provided for the connection with the printed circuit board of the electronic device, can have different designs, depending on the requirements of the printed circuit board. By way of example, they may be embodied using SMT for the connection with the printed circuit board of the electronic device.

They can likewise be designed for a connection using press-fit technology or for a soldered connection.

According to the invention, provision can be made for the electronic component, which connects contact elements via the printed circuit board element, to form or have a surge suppressor. This surge suppressor may be associated with a plurality of lines.

According to the invention, provision can likewise be made for the printed circuit board element in the socket to have an interference suppressor for suppressing interference in the data signal. This interference suppressor can be inserted directly into the signal path of the data lines. In particular, it may be a current-compensated inductor.

Provision can likewise be made for an interference suppression in the voltage supply line to be arranged in the socket, it preferably being a filter of at least first order.

What the invention allows is that the producer or designer of the printed circuit board and the circuit implemented thereon does not have to consider the problem of interference suppression or the protection against surges. All that needs to be done is to attach a socket provided with these protection apparatuses onto the printed circuit board in question. Should it turn out that interference still occurs in a normal socket, this normal socket can be replaced by the socket proposed here. If demands or regulations in respect of interference resistance are tightened, all that needs to be done is to replace one socket with a socket that satisfies the new regulations or demands.

Further features, details and advantages of the invention emerge from the claims and the abstract, the wording of both being included in the contents of the description by reference, from the following description of preferred embodiments of the invention and from the drawing, in which:

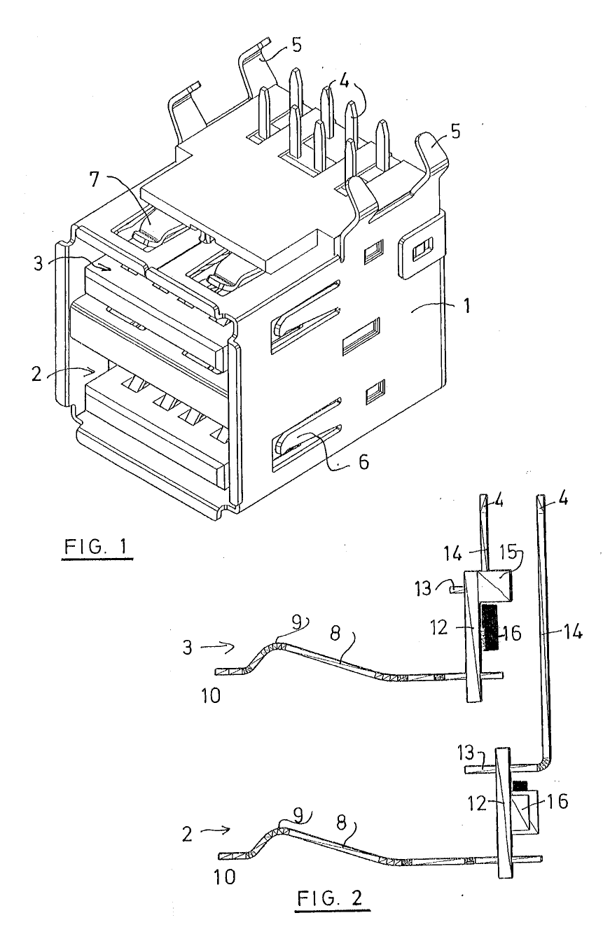

FIG. 1 shows a perspective view of a socket according to the invention;

FIG. 2 schematically shows the arrangement of the contact elements within the socket from FIG. 1;

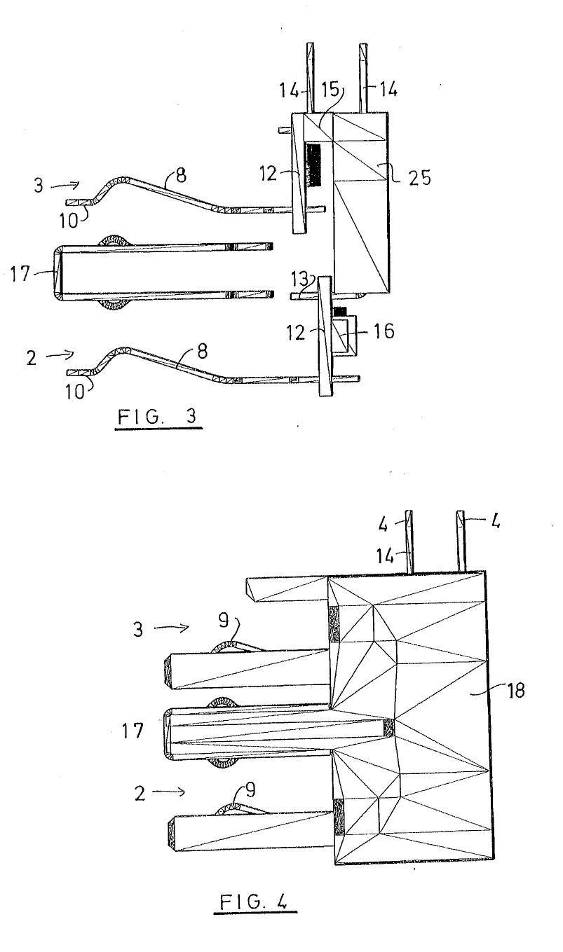

FIG. 3 shows the arrangement of the contact elements with further parts of the socket;

FIG. 4 shows the holding element accommodating the contact elements;

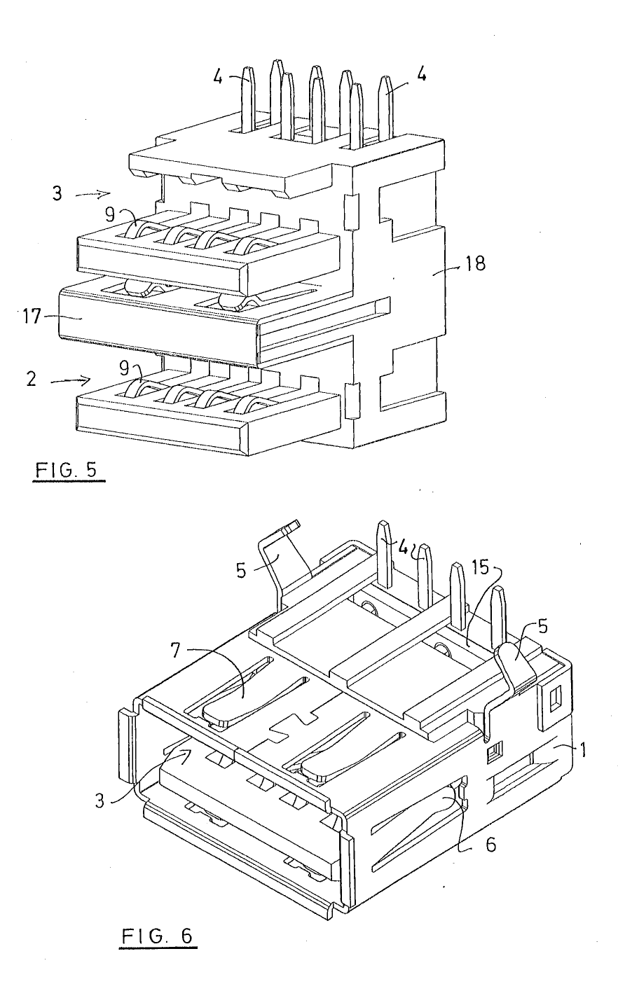

FIG. 5 shows a perspective view of the socket without housing;

FIG. 6 shows a perspective view of a socket in a second embodiment;

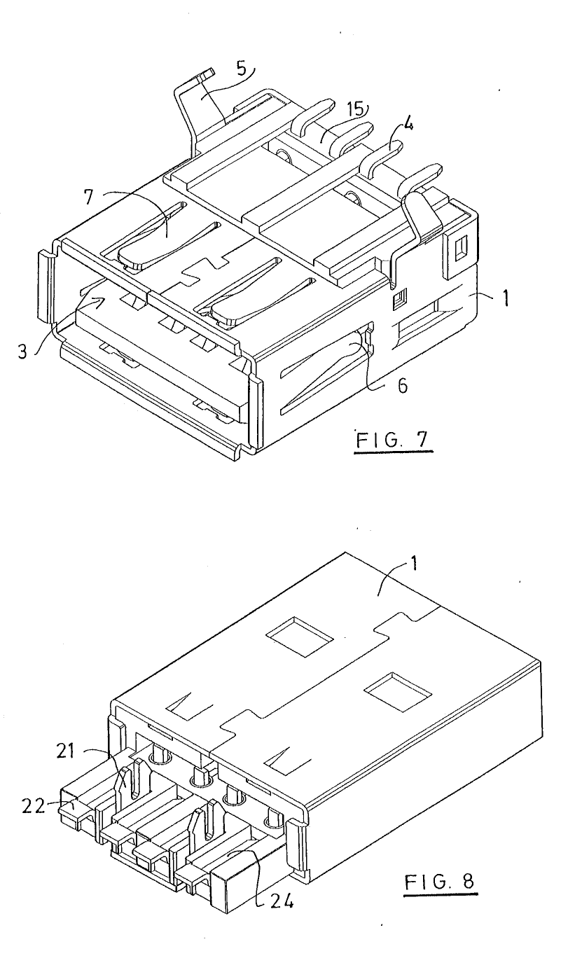

FIG. 7 shows a socket, corresponding to FIG. 6, of a modified embodiment;

FIG. 8 shows a once again modified embodiment of a socket according to the invention;

FIG. 9 shows the arrangement of the contact elements in the socket from FIG. 8; and

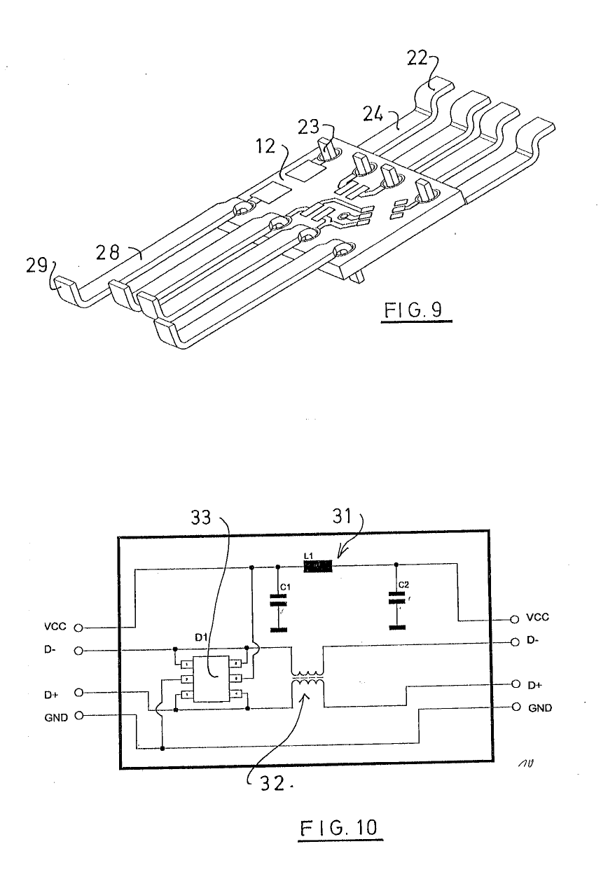

FIG. 10 shows the circuit realized on the printed circuit board element in the socket.

FIG. 1 illustrates a socket according to the invention in a perspective view from below and from the front. The socket contains a housing 1, which consists of metal and thus simultaneously embodies a shielding. On the front side, two receptacles 2, 3 for respectively one USB connector can be identified obliquely on the left. On the underside of the housing, i.e. at the top in FIG. 1, four contact pins 4 project out of the housing of the socket; these contact pins are provided to be soldered into through-plated bores in a printed circuit board. The contact pins are the ends of the contact elements between which and the contact elements of a connector to be plugged in an electrical connection is intended to be established. The housing 1 of the socket then also contains clips 5, which are provided for mechanically securing the socket in the housing of the electronic device. Thus, the illustrated embodiment is a USB socket. The walls of the housing 1 contain lateral resilient tongues 6, and there are resilient tongues 7 on the underside, for mechanically securing a plugged-in connector.

In the illustrated embodiment, the socket is conceived for two USB connectors. There are practically no differences to a conventional socket in terms of its outer shape and dimensions.

Attention is now turned to FIG. 2, which shows the contact elements of the socket from FIG. 1 in a cross-sectional view, without the remaining individual parts of the socket. The orientation has again been selected such that the contact pins 4, which project out of the underside of the housing 1, are oriented upwards.

A total of four contact elements 8 are provided for each of the two receptacles 2, 3 of the socket, which contact elements are arranged one behind the other in the drawing of FIG. 2. The contact elements 8 have a contacting bend 9, by means of which they butt against the contact surfaces of the connectors, if a connector has been plugged in. The contact elements provided for contacting the connector are also referred to as socket contact elements 8 below. In the drawing of FIG. 2, the connectors are plugged-in from the left. The inner ends 11 facing away from the free ends 10 of the socket contact elements 8 have been pressed through through-plated holes of a printed circuit board element 12 and are soldered to the latter. The printed circuit board element 12 has further holes, into which the inner ends 13 of the device contact elements 14, which are provided for the printed circuit board, have been plugged. The regions of the device contact elements 14 directed into the interior of the device form the contact pins 4.

In order to simplify the installation and increase the stability, the four device contact elements 14 of the upper receptacle 3 have been inserted into an insulation body 15 in the region of their bend.

For the purposes of simplifying the illustration, no insulation body 15 has been illustrated for the device contact elements 14 of the lower receptacle 2. Since the contact pins 4 should end in the same plane, the device contact elements 14 accordingly have a longer design than the device contact elements 14 in the upper receptacle 3.

Individual electronic components 16, which have been inserted into the electrical connection between the holes and by means of which the corresponding ends of the socket contact elements 8 and the device contact elements 14 are conductively connected, are arranged and connected on the printed circuit board elements 12 on the right-hand side in FIG. 2.

Thus, the only electrical connection between the socket contact elements 8 and the associated device contact elements 14 runs over the circuit-board conductors of the printed circuit board elements 12.

FIG. 3 now shows that the longer limbs of the device contact elements 14 are also arranged in an insulation body 25. What is additionally shown is that a U-shaped shielding plate 17, which is held in the socket, is arranged between the two receptacles 2 and 3 in order to complete the receptacles for the connectors.

In order to hold the contact elements 8, the shielding plate 17 and the printed circuit board elements 12, the housing 1 of the socket according to the invention contains a holding element 18, which is embodied as an insulation body and holds the various parts such that they can fulfil their respective function. Thus, FIG. 4 shows a side view of the socket without the housing 1.

FIG. 5 shows a perspective view of the holding element 18 with the parts held thereby, this view corresponding to that of FIG. 1. What can be seen here is that the socket contact elements 14 are accommodated in recesses, which ensure that the contact elements come to rest at the right point and cannot deviate laterally.

In the embodiment treated above, there are two receptacles, arranged one above the other, for plugging in two USB connectors. FIG. 6 now shows an illustration, corresponding to that in FIG. 1, of a socket, which only has a single receptacle 3 for one USB connector. Otherwise the individual parts are similar to those in the receptacle 3 at the top in FIG. 1. The socket is also provided here for being pressed into through-plated bores of a device printed circuit board with its contact pins 4.

FIG. 7 shows an illustration corresponding to FIG. 6, in which the contact pins 4 have been bent over after emerging from the insulation body 15 such that they are situated in a plane parallel to the plug-in direction of the connector.

FIG. 8 shows a further embodiment, with this time the perspective view from the rear side being illustrated, i.e. from the device side of the socket. Here latching elements 21 are provided for mechanically securing the housing 1. The ends 22 of the device contact elements 24 to be connected to the printed circuit board are situated in a plane parallel to the plug-in direction of the connector.

FIG. 9 shows the arrangement of the contact elements in the socket of FIG. 8. The socket contact elements 28 have a straight-line design; their front ends are bent upwards at a right angle. Their rear ends are bent downwards at a right angle and have been inserted into the through-plated bores of the printed circuit board element 12. The device contact elements 24 have a similar design; their inner ends 23 have been inserted into the printed circuit board element 12 from below. In order to attach the electronic components, solder pads, to which the electronic components are soldered, are arranged on the visible upper side of the printed circuit board element 12.

FIG. 10 shows the connection of the electronic components to be attached to the printed circuit board element 12 on the basis of a USB connector. In FIG. 10, the left-hand side is the connector side and the right-hand side is the device side.

An element 31 for interference suppression is inserted in the supply voltage line. This element may be a component that either can be soldered on passively or is integrated into the printed circuit board.

A current-compensated inductor 32 as an interference suppressor has been inserted in the signal path of the data lines.

An element 33 with diodes contained therein has been inserted between all lines as surge suppressor.

By arranging these measures on a printed circuit board element in the socket itself, it is possible to ensure that the optimum protection apparatuses and interference suppression means are available at all times.

1. Socket, more particularly a USB socket, comprising
a receptacle space for the plug-in section of a USB connector, at least four socket contact elements arranged in the receptacle space for contacting the USB connector,
at least four device contact elements leading out of the socket, which device contact elements are provided for connection with the printed circuit board of an electronic device,
a printed circuit board element arranged in the USB socket, to which printed circuit board element the device contact elements and the socket contact elements are electrically connected, wherein
the electrical connection between the socket contact elements arranged in the receptacle space and the contact elements of the associated electronic device is brought about by the wiring of the printed circuit board element.

2. USB socket according to claim 1, wherein the printed circuit board element contained in the USB socket has at least one electrical or electronic circuit element, which is inserted in the electrical connection between at least one socket contact element and at least one device contact element.

3. Socket according to claim 1, wherein one of the socket contact elements and the device contact elements are arranged and held in an insulating holding element of the socket.

4. Socket according to claim 3, with a metallic housing accommodating the holding element.

5. Socket according to claim 1, wherein one of the socket contact elements and the device contact elements are soldered to the printed circuit board element.

6. Socket according to claim 1, wherein one of the socket contact elements and the device contact elements are pressed into through-plated bores in the printed circuit board element.

7. Socket according to claim 1, wherein end regions of the device contact elements, routed out of the socket are arranged for the connection with the printed circuit board of the electronic device in SMT (Surface Mounting Technology).

8. Socket according to claim 1, wherein end regions of the device contact elements, routed out of the socket, are arranged for the connection to the printed circuit board of the electronic device using press-fit technology.

9. Socket according to claim 1, wherein end regions of the device contact elements, routed out of the socket, are arranged for the connection to the printed circuit board of the electronic device using soldering.

10. Socket according to claim 1, wherein the printed circuit board element in the socket contains a surge suppressor.

11. Socket according to claim 1, wherein the printed circuit board element in the socket has an interference suppressor for suppressing interference in the data signal, which interference suppressor is inserted directly in the signal path of the data lines, in particular a current-compensated inductor.

12. Socket according to claim 1, wherein the printed circuit board element in the socket has interference suppression in the voltage supply, preferably a filter of at least first order.
